(19) United States
(12) Patent Application Publication
(10) Pub. No.: US 2025/0037131 A1
(43) Pub. Date: Jan. 30, 2025

(54) COMPUTER-BASED SYSTEMS AND METHODS FOR BUILDING AND IMPLEMENTING AN ATTACK NARRATIVE TREE TO IMPROVE SUCCESSFUL FRAUD DETECTION AND PREVENTION

(71) Applicant: PAYPAL, INC., San Jose, CA (US)

(72) Inventor: Yue Qian, Shanghai (CN)

(21) Appl. No.: 18/282,468

(22) PCT Filed: Dec. 1, 2022
(86) PCT No.: PCT/CN2022/135963

§ 371 Date: Sep. 15, 2023

(51) Int. Cl. G06Q 20/40; G06F 21/55

(52) U.S. Cl. CPC G06Q 20/4016; G06F 21/552

(57) ABSTRACT

A method includes determining for each one of at least two variables associated with each one of a plurality of electronic transactions, at least a first group of the plurality of electronic transactions and a second group of the plurality of electronic transactions. The method further includes determining, for each of the at least the first group of transactions and the second group of transactions, a factor indicative of both a percentage of electronic transactions in a group that are fraudulent and a percentage of a total amount associated with the electronic transactions in the group that are fraudulent. The method further includes determining a subset of the plurality of electronic transactions based on a variable of the at least two variables having or exceeding a predetermined threshold value. The predetermined threshold value is determined based on the factor of the first group and the second group.

### CROSS-REFERENCE TO RELATED PATENT APPLICATION

This application is a 371 National Stage application of and claims priority to International PCT Application No. PCT/CN2022/135963, filed Dec. 1, 2022, the entire contents of which is hereby incorporated by reference in its entirety.

### TECHNICAL FIELD

This disclosure relates generally to security in computer systems, and more particularly detecting and mitigating fraudulent attempts to access computer systems.

### BACKGROUND

Malicious users are a big problem for web services. Fraudsters are constantly finding new ways to circumvent risk mitigations causing loss for a variety of service providers and customers. Fraud techniques are constantly changing and evolving, and new fraud trends keep emerging. Businesses are constantly trying to detect and remove malicious users from stealing money and information including user data.

### SUMMARY

An illustrative method includes determining, by a computer system, for each one of at least two variables associated with each one of a plurality of electronic transactions, at least a first group of the plurality of electronic transactions and a second group of the plurality of electronic transactions. The method further includes determining, by the computer system for each of the at least the first group of transactions and the second group of transactions, a factor indicative of both a percentage of electronic transactions in a group that are fraudulent and a percentage of a total amount associated with the electronic transactions in the group that are fraudulent. The method further includes determining, by the computer system, a subset of the plurality of electronic transactions based on a variable of the at least two variables having or exceeding a predetermined threshold value. The predetermined threshold value is determined based on the factor of the first group and the second group.

An illustrative system includes a processor and a non-transitory computer-readable medium having stored thereon instructions that are executable by the processor to cause the system to perform operations including, determine for each of a first variable and a second variable associated with each one of a plurality of electronic transactions, a factor associated with each of a plurality of values or ranges of values of each respective variable. The factor is indicative of both a percentage of electronic transactions of the plurality of values or ranges of values that are fraudulent and a percentage of a total amount associated with the electronic transactions in the group that are fraudulent. The operations further include determine a first subset of the plurality of electronic transactions based on the first variable and the factor associated with the plurality of values or ranges of values of the first variable. The operations further include determine a second subset of the plurality of electronic transactions from the first subset of the plurality of electronic transactions based on the second variable and the factor associated with the plurality of values or ranges of values of the second variable. The second variable is used to determine the second subset of the plurality of electronic transactions after the first variable is used to determine the first subset of the plurality of electronic transactions based on the factor of at least one of the plurality of values or ranges of values of the first variable being higher than the factor of at least one of the plurality of values or ranges of values of the second variable.

An illustrative non-transitory computer-readable medium having stored thereon instructions that are executable by a processor to cause a system to perform operations including determine for each of a first variable and a second variable associated with each one of a plurality of electronic transactions, a concentration of loss factor associated with each of a plurality of values or ranges of values of each respective variable. The operations further include determine a subset of the plurality of electronic transactions based on the plurality of values or ranges of values of each respective variable. The determining the subset includes reduce the plurality of electronic transactions to a first subset of electronic transactions based on a first value or range of values of the first variable or the second variable having a highest concentration of loss factor of each of the plurality of values or ranges of values of the first variable and the second variable. The determining the subset further includes reduce the first subset of electronic transactions to a second subset of electronic transactions based on a second value or range of values of the first variable or the second variable having a next highest concentration of loss of the plurality of values or ranges of values of the first variable and the second variable, provided that the second value or range of values is not associated with a same variable as the first value or range of values having the highest concentration of loss.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein, including in the various drawings and figures, are not to be interpreted as limiting, but merely as a representative basis for teaching one skilled in the art to variously employ one or more illustrative embodiments.

FIG. 1 is a block diagram view of an example system including client systems, a network, and a backend system, in embodiments.

FIG. 2 is a flow chart illustrating an example method of building and implementing an attack narrative tree for fraud detection and prevention, in embodiments.

FIGS. 3A and 3B are diagrams illustrating example ways to group electronic transactions using numerical variables, in embodiments.

FIG. 4 is a table illustrating example variable ordering for applying threshold variable values to build an attack narrative tree, in embodiments.

FIG. 5 is a diagram illustrating an example attack narrative tree for fraud detection and prevention, in embodiments.

FIG. 6 is a table illustrating an example output logic for groups of electronic transactions having high concentration of loss based on an attack narrative tree, in embodiments.

FIG. 7 is a flow chart illustrating an example method of using an output of an attack narrative tree to detect fraudulent electronic transactions, in embodiments.

FIG. 8 is a flow chart illustrating an example method of using an output of an attack narrative tree to analyze in-process electronic transactions, in embodiments.

FIG. 9 is a diagrammatic view of an example of a computing environment, in embodiments.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Described herein are methods, systems, computer readable media, etc. for building and implementing an attack narrative tree (ANT) to improve successful fraud detection and prevention. In particular, the ANTs described herein provide for identifying characteristics of fraudulent electronic transactions, so that electronic transactions not identified as being fraudulent may be identified based on their similar characteristics to those identified using the ANTs.

The ANTs described herein particularly identify groups of electronic transactions that are fraudulent and have a high concentration of loss. The concentration of loss, as used herein, relates to both a number of electronic transactions and a magnitude of loss associated with each electronic transaction. That is, higher concentrations of loss occur with groups of transactions that have higher incidences (e.g., frequency) of fraudulent electronic transactions and where those transactions have a higher magnitude of loss. Thus, in various embodiments, a group of transactions with a relatively small percentage being fraudulent may still have a high concentration of loss if the group of transactions has a high magnitude of loss. Similarly, a group of transactions that are mostly or all fraudulent may have a lower relative concentration of loss due to the transactions having a relatively low magnitude of loss. Thus, using the ANTs and methods for building them described herein, groups of transactions may be identified that have high concentrations of loss, and characteristics of those groups of transactions may be determined to identify additional electronic transactions with similar characteristics that may be fraudulent. Those additional electronic transactions may therefore be flagged for additional review, blocked from processing, etc., as desired to reduce the amount of fraudulent electronic transactions, and especially reduce groups of transactions with a higher concentration of loss.

As such, the methods, systems, and computer readable media described herein provide the technical improvement to computing systems to more accurately and to more often identify electronic transactions that may be fraudulent. The methods, systems, and computer readable media described herein also provide the technical improvement to backend client devices to more accurately characterize and identify characteristics of electronic transactions that may be indicative of an electronic transaction being fraudulent.

The various embodiments described herein therefore provide improved technical solutions for various technical problems that occur in previous methods for detecting whether electronic transactions are fraudulent. In particular, the aspects of grouping electronic transactions, determining concentrations of loss for those groupings, determining thresholds associated with groupings that are indicative of high concentrations of loss of electronic transactions, and using those thresholds to build an attack narrative tree (ANT) represent technical aspects that provide a significant technical advantage over prior systems that do not provide such functionality. In addition, the results of the ANTs that are built may be used to identify, flag, filter, block, etc. electronic transactions in the future that have similar characteristics to those identified based on the ANTs. The tactics and strategies that scammers, fraudsters, etc. use may be constantly changing, and the various embodiments herein further provide for identifying new patterns, strategies, etc. of fraudulent electronic transactions, and adjusting fraudulent electronic transaction identification methods accordingly. As such, the technical aspects of the embodiments described herein provide specific technical improvements for backend client devices in detecting and preventing fraudulent electronic transactions.

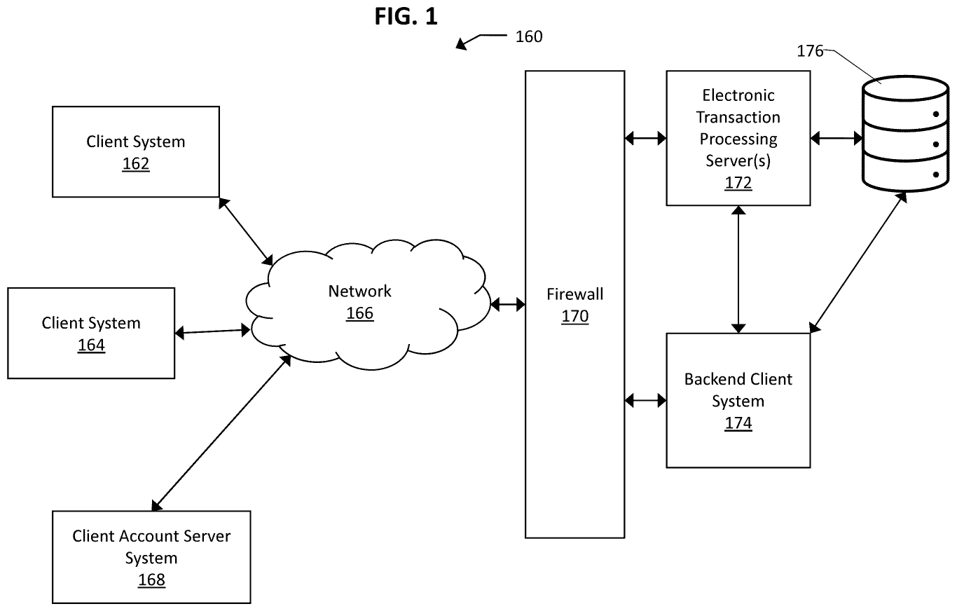

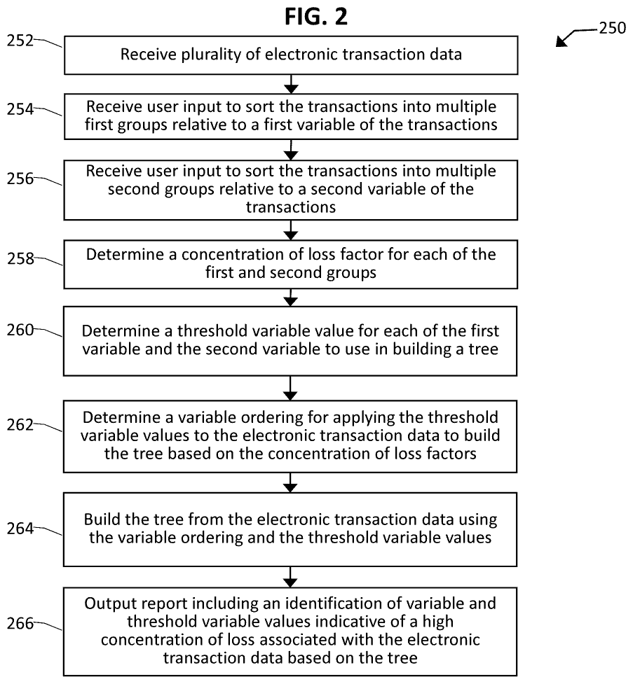

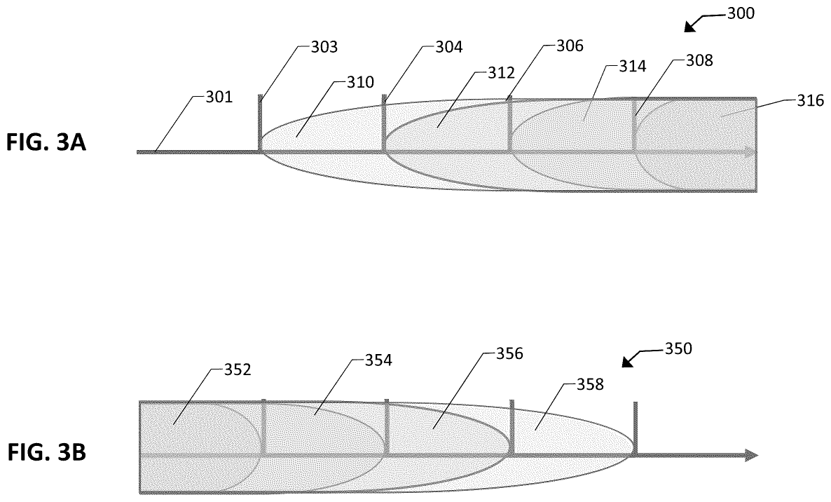

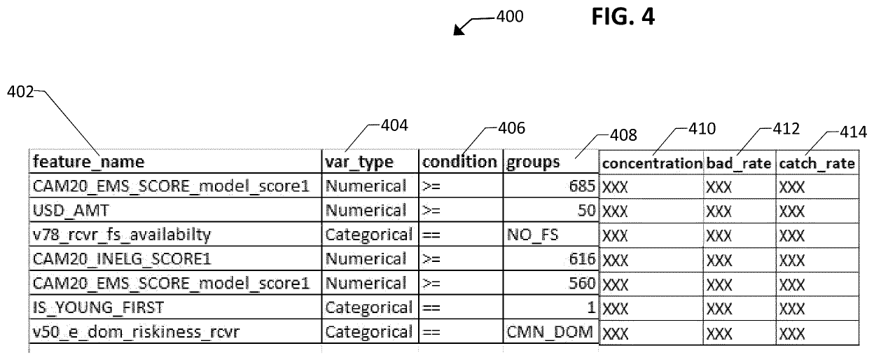

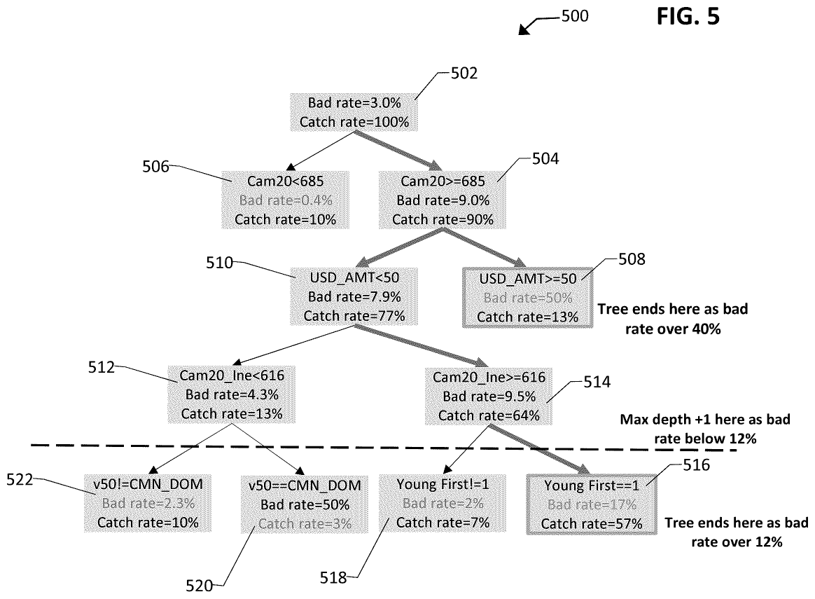

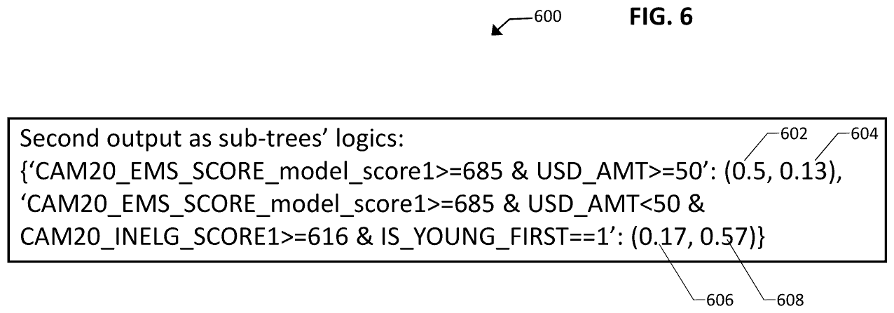

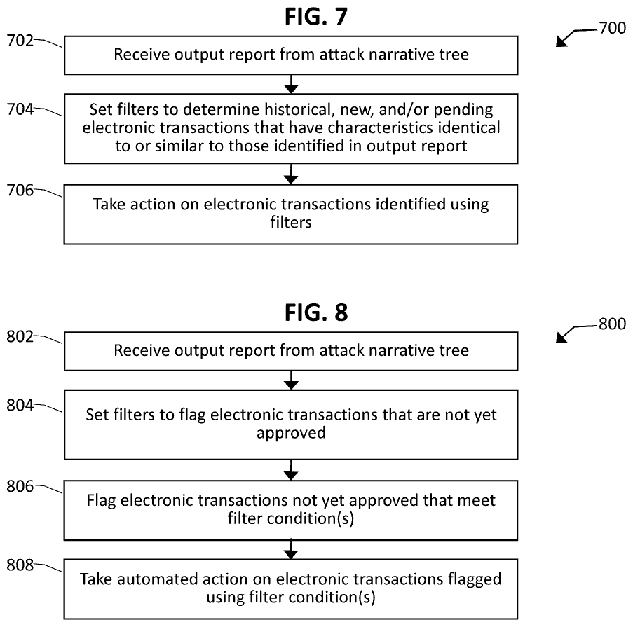

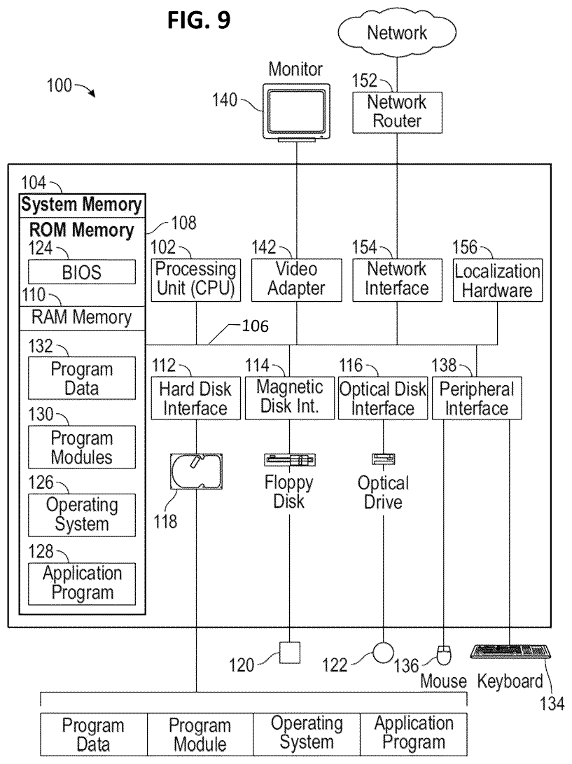

First, with respect to FIG. 1, an illustrative example system including client systems, a network, and a backend system is described. With respect to FIG. 2, an illustrative method of building and implementing an attack narrative tree for fraud detection and prevention is described. With respect to FIGS. 3A and 3B, illustrative diagrams showing example ways to group electronic transactions using numerical variables are described. With respect to FIG. 4, an illustrative table for ordering variables for applying threshold variable values to build an attack narrative tree is described. With respect to FIG. 5, an illustrative attack narrative tree (ANT) for fraud detection and prevention is described. With respect to FIG. 6, an illustrative output logic for groups of electronic transactions having high concentration of loss built using an attack narrative tree is described. With respect to FIG. 7, an illustrative method of using an output of an attack narrative tree to detect fraudulent electronic transactions is described. With respect to FIG. 8, an illustrative method of using an output of an attack narrative tree to analyze in-process electronic transactions is described. Finally, with respect to FIG. 9, an illustrative computing environment that may be used in conjunction with the methods and processes of this disclosure will be described.

In various embodiments, different computerized devices, systems, aspects are described herein, for example with respect to FIG. 1. Any combination of the various computing components, devices, and/or aspects described herein may be or may include one or more aspects of a computing device or system shown in and described with respect to FIG. 9. For example, client systems 162 and 164, client account server system 168, backend client system 174, electronic transaction processing server(s) 172, database 176, etc. of FIG. 1 may include some, all, or additional computing components as shown in and described with respect to FIG. 9. For example, the client systems 162 and 164 may desire to carry out an electronic transaction between their respective devices and/or between accounts associated with users of those client systems. The client systems 162 and 164 may communicate with one another and the electronic transaction processing server(s) 172 (hereinafter the server 172, though the server 172 may be multiple servers), where the server 172 may authorize or approve the transaction for execution between the client systems 162 and 164 and/or the accounts associated with users of those systems. Once approved, a message may be transmitted from the server 172 to a client account server system 168 to execute the electronic transaction. A backend client system 174 and/or the server 172 may be used to implement various of the embodiments disclosed herein including, for example, grouping electronic transactions, determining concentrations of loss for those groupings, determining thresholds associated with groupings that are indicative of high concentrations of loss of electronic transactions, using those thresholds to build an attack narrative tree (ANT), and using the ANT to determine aspects of transactions that may be indicative of transactions having higher concentrations of loss. A user may further use the backend client system 174 to change or adjust how electronic transactions are authorized by the server 172, so that the information from the ANT may be used to authorize, block, suspend, flag, etc. electronic transactions that may be fraudulent.

In various embodiments, any of the devices of FIG. 1 may additionally or alternatively be used to implement or execute the methods or processes described herein, such as those described herein with respect to a database, server, cloud service/server, etc. (e.g., a client system may store similar data as database 176, the server 172 may be a group of cloud servers, the client account server system 168 may be used to authorize transactions, etc.). In addition, one or more of the computing devices, systems, etc. described herein may be in communication with any or all of the other devices shown in FIG. 1 to implement the systems and methods described herein (e.g., where one computing device is a virtual machine running instructions stored on and/or executed on another computing device).

In FIG. 1, a block diagram of a system 160 is shown. In this diagram, system 160 includes client systems 162, 164. System 160 also includes a client account server system 168, electronic transaction processing server(s) 172, operational database 176, backend user system 174, firewall 170, and network 166.

Note that many other permutations of this figure are contemplated (as with all figures). While certain connections are shown (e.g. data link connections) between different components, in various embodiments, additional connections and/or components may exist that are not depicted. As will be appreciated, large numbers of devices are omitted from this diagram for simplicity-thus, in various embodiments, routers, switches, load balancers, computing clusters, additional databases, servers, and firewalls, etc., may all be present. Components may be combined with one other and/or separated into one or more systems in this figure, as in other figures.

Note that the server 172 and the backend client system 174 are shown as being connected to firewall 170, one another, and the operational database 1796, but this architecture is only an example. Backend client system 174 may be connected to the server 172 and other devices as well (i.e., a number of different devices may send and receive data and/or commands to/from either or both of the server 172 and the backend client system 174). In various instances, other fraud monitoring or analysis systems not depicted may send data to the server 172 and/or the backend client system 174. In short, the server 172 may be configured to receive and access data relating to electronic transactions from any device residing on a network, in various embodiments, and such data may come from multiple sources. The server 172 may comprise one or more computing devices in various embodiments and can be hosted in a cloud environment or other compute cluster environment in some embodiments.

Client systems 162, 164 may be any user computer system that can potentially interact with the server 172. The server 172 may facilitate one or more services, such as account access and electronic payment transactions (e.g., as may be provided by PayPal.com™). The server 172 may thus also facilitate access to various electronic resources, which can include an account, data, programs/functionality, etc.

The server 172 may be any computing device configured to provide access to electronic resources. This may include providing web content, in various embodiments, as well as access to functionality provided a web client (or via other protocols, including but not limited to SSH, FTP, database and/or API connections, etc.). Services provided may include serving web pages (e.g. in response to a HTTP request) and/or providing an interface to operational database 176. The operational database 176 may include various data, such as user account data, system data, fraudulent electronic transaction data, other data related to electronic transactions (e.g., whether fraudulent or not) and any other information. Multiple such databases may exist in various embodiments, and may be spread across one or more data centers, cloud computing services, etc. The server 172 may comprise one or more computing devices each having a processor and a memory (e.g., as shown in FIG. 9). Network 166 may comprise all or a portion of the Internet.

The server 172 may correspond to an electronic payment transaction service such as that provided by PayPal™ in various embodiments. The server 172 may have a variety of associated user accounts allowing users to make payments electronically and to receive payments electronically. A user account may have a variety of associated funding mechanisms (e.g. a linked bank account, a credit card, etc.) and may also maintain a currency balance in the electronic payment account. A number of possible different funding sources may be used to provide a source of funds (credit, checking, balance, etc.). User devices (smart phones, laptops, desktops, embedded systems, wearable devices, etc.) may be used to access electronic payment accounts such as those provided by PayPal™. In various embodiments, quantities other than currency may be exchanged via the server 172, including but not limited to stocks, commodities, gift cards, incentive points (e.g. from airlines or hotels), etc. The server 172 may also correspond to a system providing functionalities such as API access, a file server, or another type of service with user accounts in some embodiments (and such services can also be provided via content the server 172 in various embodiments).

The database 176 may include a transaction database having records related to various transactions taken by users of a transaction system in the embodiment shown. These records can include any number of details, such as any information related to a transaction or to an action taken by a user on a web page or an application installed on a computing device (e.g., the PayPal app on a smartphone). Many or all of the records in the database 176 may be transaction records including details of a user sending or receiving currency (or some other quantity, such as credit card award points, cryptocurrency, etc.). The database information may include two or more parties involved in an electronic payment transaction, date and time of transaction, amount of currency, whether the transaction is a recurring transaction, source of funds/type of funding instrument, and any other details. Such information may be used for bookkeeping purposes as well as for risk assessment (e.g. fraud and risk determinations may be made using historical data; such determinations may be made using systems and risk models not depicted in FIG. 1 for purposes of simplicity).

Some of the methods and processes described herein may be carried out by a user on the backend client system 174, such that a backend user may sort and analyze data related to electronic transactions that are fraudulent as described herein. In this way, the backend user may identify characteristics of electronic transactions for analyzing additional transactions that may not be identified as fraudulent, determine risk associated with transactions being carried out or already having been carried out, etc. The backend client system 174 (e.g., in conjunction with the server 172 and the operational database 176) may be used to build ANTs to determine characteristics and groups of transactions that may be fraudulent, so that backend clients (e.g., other users associated with a same entity as the backend client system 174) may use the ANTs and/or the methods described herein to process or analyze transactions that may be fraudulent, or take other actions based on a determination that a transaction or group of transactions may be fraudulent.

FIG. 2 is a flow chart illustrating an example method 250 of building and implementing an attack narrative tree for fraud detection and prevention. At an operation 252, a plurality of electronic transaction data may be received. For example, the data may be received by the backend client system 174 of FIG. 1 from the operational database 176. The data may include, for example, data regarding a plurality of electronic transactions including data for historical electronic transactions that have been previously deemed to be fraudulent. For example, the backend client system 174, the server 172, users of the same, etc. may determine that certain transactions are fraudulent, either while the transactions are being carried out or after the fact (e.g., after investigation into the transactions). When an electronic transaction is determined to be fraudulent, data relating to the electronic transaction may be stored in the operational database 176, for example, along with data indicating that the electronic transaction is deemed to be fraudulent. As such, the backend client system 174, for example, can receive data about fraudulent transactions to analyze the transactions, build ANTs as described herein, take subsequent actions based on the ANTs, etc.

In various embodiments, the fraudulent electronic transaction data may include fraudulent electronic transactions that were completed and/or fraudulent electronic transactions that were not completed. As such, data may be used whether or not the server 172, for example, successfully identified a fraudulent transaction before authorizing it (e.g., a given transaction may be identified as fraudulent after it has already been authorized, processed, executed, etc.), such as by a backend client system.

At an operation 254, user input may be received to sort the transaction data received at the operation 252 into multiple first groups relative to a first variable of the transactions. A variable of a transaction may be a data field associated the plurality of transactions, such as transaction amount if it is a transfer currency. The user input may indicate which variable of a plurality of variables that should be used to separate the transactions into groups, and/or may indicate how to separate the transactions into groups relating to the selected variable. In various embodiments, a system may also separate the transactions into groups for some or all of the variables associated with the transactions. In various embodiments, the variables may be determined automatically (e.g., without specification by a user). Similarly, in various embodiments, the manner in which the transactions are grouped based on a given variable may be predetermined and/or automated, such that a user specification of how to group the transactions may not be received.

In various embodiments, for example, a computer system may determine, for each one of at least two variables associated with each one of a plurality of electronic transactions, at least a first group of the plurality of electronic transactions and a second group of the plurality of electronic transactions. FIGS. 3A and 3B show an example of how transactions may be grouped for a single numerical variable. For example, in FIGS. 3A and 3B, an entire group of a plurality of transactions may be represented by a line 301 and sorted according to the values of a given variable being used to sort the transactions. For example, a variable of each of the plurality of electronic transactions may have a value that represents one of a plurality of discrete values (e.g., integers, a predetermined set of text values, a dollar value, a true/false (e.g., binary I/O) value, etc.). If the variable being analyzed is transaction value, for example, the transactions represented at the left end of the line 301 may be for a lowest amount, while the transactions represented at the right end of the line 301 may be for a highest amount (e.g., transactions are organized/ordered according to transaction value from lowest to highest).

Numerical data may be separated by quantiles for example (though other thresholds for organizing the transaction data may be used in various examples), as marked by lines 303, 304, 306, and 308. For example, the lowest 20% of transactions by transaction amount may be associated with the line 301 to the left of quantile line 303, the lowest 40% of transactions may be associated with the line 301 to the left of quantile line 304, etc. The groups 310, 312, 314, 316 in FIG. 3A may represent how transactions are grouped according to various embodiments herein. Again where the line 301 may represent a plurality of transactions ordered according to transaction amount, the group 316 may represent the top quantile of transactions (e.g., all the transactions to the right of quantile line 308 or the highest 20% of transactions by amount), the group 314 may represent the top two quantiles of transactions of transactions (e.g., all the transactions to the right of quantile line 306 or the highest 40% of transactions by amount), the group 312 may represent the top two quantiles of transactions of transactions (e.g., all the transactions to the right of quantile line 304 or the highest 60% of transactions by amount), the group 310 may represent the top two quantiles of transactions of transactions (e.g., all the transactions to the right of quantile line 303 or the highest 80% of transactions by amount), etc.

Similarly, in FIG. 3B which shows groupings in a transaction set 350, the transactions may be grouped based on the quantile lines and below: group 352 may be the lowest 20% of transactions by amount, group 354 may be the lowest 40% of transactions by amount, group 356 may be the lowest 60% of transactions by amount, group 358 may be the lowest 80% of transactions by amount, etc. Accordingly, as demonstrated in FIGS. 3A and 3B transaction data may be grouped based on the values of a given variable associated with each transaction. In various embodiments, for the same variable, both the groupings of FIGS. 3A and 3B may be made for example (e.g., for 8 total groupings). As such, the same transaction data (e.g., the transaction data between quantile lines 303 and 308) may be included in multiple groupings (e.g., where both the groupings shown in FIGS. 3A and 3B are created. In other words, a first quantity of transactions in a first group of electronic transactions may be greater than a second quantity of a second group of electronic transactions, and each one of the second quantity of the second group may be included in the first group in various embodiments.

The method of grouping numerical variables as shown in and described with respect to FIGS. 3A and 3B may be used, for example, instead of a bin split method, to avoid overfitting of bins to fraudulent transaction groups and to better catch or adjust to fraudster behavior change. In other words, the grouping as shown in and described with respect to FIGS. 3A and 3B may better account for when fraudsters change tactics. Splitting the groups in this way, for example, may further be advantageous in organizations where there are a large number of business units that may characterize risk for transactions in different ways (e.g., calculate risk scores for transactions using different methodologies). In such examples, the groupings may better accommodate the use of different risk scores calculated in different ways into a single analysis of fraudulent transactions as described herein.

In various embodiments, the grouping as shown in and described with respect to FIGS. 3A and 3B may be performed for more than one variable. At an operation 256, user input is received to sort the transactions into multiple second groups relative to a second variable associated with the transactions (and similar steps may be performed for one or more additional variables as desired). That is, for the group of transactions, multiple groupings may be determined for each of a plurality of variables. For example, a first set of groupings may be formed based on transaction value, a second set of groupings may be formed based on a risk score using a predictive model, etc.

Groupings may also be created differently based on a type of variable. For example, the groupings may be created as shown in or similar to the groupings demonstrated in FIGS. 3A and 3B where there are a large number of possible values for the given variable. If the variable only has a binary (e.g., 0/1, yes/no) value, there may only be two groups made for that variable. If a variable has a text value (e.g., name of bank to which a paying user processing the transaction is associated with), the number of groups may be equal to the number of different banks listed in the transaction data (e.g., where each variable having the same bank or text string is put in a same group). As such, for each variable being considered by the system, multiple groupings may be determined based on the values of the variables themselves. In other words, for variables with a text value, the number of groups may be related to the number of different values present in the variable. For example, there may be twenty different banks listed in a variable, so COL may be calculated for the groups of transactions associated with each bank. However, for purposes keeping groups/variables for building the ANT and chart in FIG. 4, only a subset of those twenty groups may be kept based on COL. For example, five groups of the twenty may be kept with the highest COL to pass into a next step for the purpose of building the ANT.

In various embodiments, the variables may be different types of data. For example, a variable may indicate whether the first variable comprises whether a transaction is a first transaction of a user (e.g., yes/no, 1/0, true/false), whether a transaction is within a predetermined threshold of the first transaction of the user (e.g., whether a transaction is one of the user's first two transactions, first three transactions, first five transactions, first ten transactions, etc.), an institution name through which the electronic transaction is processed, an institution type (e.g., bank, credit union, credit card company, brokerage, etc.) through which the electronic transaction is processed, an identity of the user associated with the electronic transaction, or a type of user who processed the transaction (e.g., if there are different types of user accounts available as part of a payment processing/authorization system), a payment type (e.g., wire transfer, credit card, automated clearing house (ACH) transfer, etc.) for the transaction, a transaction amount, a calculated risk score of an electronic transaction (e.g., using a predictive model), etc.

At an operation 258, a concentration of loss factor is determined for each of the groups (e.g., the first set of groups associated with the first variable and the second set of groups associated with the second variable). A concentration of loss COL may be calculated by the following Equation 1, where bad_rate is a rate or percentage of how many transactions of a total group of transactions are bad or fraudulent, and catch rate is a rate or percentage of how many dollars of fraudulent transactions of the total group of transactions are represented by the group:

$$COL = bad\_rate * catch\_rate \qquad [ 1 ]$$

In various embodiments, the bad_rate and/or catch rate may be weighted in different ways, either with multipliers, powers/exponents, etc. For example, COL may also be calculated according to Equation 2 below, where n is a hyperparameter referred to as bad_rate weight:

$$COL = {bad\_rate}^{n} * catch\_rate \qquad [ 2 ]$$

In various embodiments, other weights may be used for any of bad_rate and/or catch rate. As such the concentration of loss may be a factor that is indicative of both a percentage of electronic transactions in a group that are fraudulent (e.g., bad rate) and/or a percentage of a total amount (e.g., of currency) associated with the electronic transactions in the group that are fraudulent (e.g., catch rate). For example, COL may be calculated according to Equation 3 below, where P bad is a percentage of bad (e.g., fraudulent) transactions that remain in a group as compared to an original group of transactions and P good is a percentage of good (e.g., non-fraudulent) transactions that remain in a group as compared to an original group of transactions.

$$COL = {bad\_rate}^{n} * catch\_rate * ( P\_bad - P\_good ) \qquad [ 3 ]$$

For example, for each of the groupings (e.g., the groupings represented by FIGS. 3A and 3B), COL may be calculated according to Equation 3. For example, a plurality of electronic transaction data received at 252 may have 100 total transactions, where 40 transactions are bad (e.g., fraudulent) and 60 transactions are good (e.g., non-fraudulent). In a quantile (e.g., group 314 or 354 of FIGS. 3A and 3B) having 40 electronic transactions where 30 are bad and 10 are good, the COL for the group may be calculated using Equation 3, where hyperparameter n is one, bad_rate is 0.75 (30 bad transactions in group divided by 40 bad total), P_bad is the same as the catch_rate (0.75 or 30 bad transactions in group divided by 40 bad total), and P_good is 0.167 (10 good transactions divided by 60 good total). As such, an additional factor may be used in Equation 3 that is indicative of concentration of how many bad versus good transactions there are in a given group. In various embodiments, a system (e.g., a backend client system) may also be configured to receive, from a user via a user interface, any or all of the weights/hyperparameters described herein, such as weights to apply to the bad_rate and/or catch_rate for calculating the concentration of loss factor(s). In other words, the weight may be user-defined to adjust how COL is calculated as desired by user using/building an ANT. As discussed below, COL calculations may be performed while splitting/building an ANT as well (e.g., at operations 262, 264), so any of the embodiments for calculating COL described herein may be used at any step where COL is used as described herein.

Concentration of loss (COL) factors may therefore be calculated at the operation 258 for each of the groups that are determined for different variables at the operations 254 and 256. COL factors may be used in various ways in various embodiments.

For example, if there are many groups (e.g., more than 5) created for a particular variable (e.g., at the operation 254 or 256), the COL factor calculated for each of the groups may be used to reduce the number of groups analyzed and used for the subsequent operations (e.g., operations after the operation 258). In various embodiments, the number of groups selected for a given variable to be used for subsequent operations may be a hyperparameter set by, for example, a user via a user interface. A user may specify, for example, a number or percentage of groups associated with different values of a variable to keep for subsequent operations. For example, for variables with a text value, the number of groups may be related to the number of different values present in the variable. For example, there may be twenty different banks listed in a variable, so COL may be calculated for the groups of transactions associated with each bank. However, for purposes keeping groups/variables for building the ANT and chart in FIG. 4, only a subset of those twenty groups may be kept based on COL. For example, five groups of the twenty may be kept with the highest COL to pass into a next step for the purpose of building the ANT. In the example of FIGS. 3A and 3B, eight total groups were determined for a transaction value amount (e.g., more than 5 groups were determined). In various embodiments, all eight of those groups may be kept for subsequent operations (e.g., in various embodiments all groups may be kept for numerical variables). However, in other embodiments, numerical variable groups may also be reduced for use in subsequent operations similar to the non-numerical variables described above. As such, a number of groups associated with particular variable values having the highest COL factors (e.g., as calculated at the operation 258) may be kept for further analysis, while other groups associated with variable values having lower COL factors may be discarded. Reducing the number of groups kept for subsequent analysis may reduce a number of less informative tree split candidates so that the results of the ANT are more useful and informative.

For groupings related to variables where there are a smaller number of groups (e.g., true/false or yes/no variables where there are only two groups), a COL will still be calculated, but the COL factor may not be used to reduce the number of groups considered for remaining analysis (e.g., used in the operations after the operation 258). In various embodiments, however, the COL factors for the groupings that remain after reducing any numbers of groupings after the operation 258 may still be used for various reasons. For example, the calculated COL factors may be used to determine threshold variable values described further herein with respect to operation 260 below (e.g., identify variable value thresholds associated with a particular group having high COL factors, so that those values may be used to populate a column 408 of FIG. 4 and build an ANT), determine variable ordering for building an attack narrative tree (ANT) with respect to operation 262 below (e.g., ordering of the rows in table 400 of FIG. 4), and therefore also in building the ANT itself at an operation 264 described below (e.g., since both the threshold variables and the variable ordering may be used to construct an ANT in various embodiments.

At an operation 260, a computer system (e.g., a backend client system 174 or a server 172 as described herein) may determine a threshold variable value for each of the variables based on the COL factors calculated for each grouping associated with each variable. For example, the system may determine a grouping associated with each variable that has a highest COL factor or may determine groupings associated with each variable that meet or exceed a predetermined threshold. State another way, from the perspective of all the transaction data received at the operation 252, the computer system determines a subset of the plurality of electronic transactions for a given variable where the COL factor is highest or meets or exceeds a predetermined threshold value. In this way, the system can determine the groupings with the highest COL factors. In various embodiments, rather than determining just a highest COL factor associated with a grouping for a given variable, multiple highest groupings associated with the given variable having the highest (or above a predetermined threshold) COL factor may be further considered/selected.

The operation 260 may be performed for more than one variable, so that groupings associated with multiple variables are determined that have the highest COL factors. For example, a second grouping including a subset of the original plurality of electronic transactions may be selected based on COL factors of the groupings based on a second variable. A third grouping including a subset of the original plurality of electronic transactions may also be selected based on COL factors of the groupings based on a third variable, etc.

At an operation 262, the computer system may determine a variable ordering for the groupings based on the determine COL factors, which may be output, for example, in a table such as the one shown in FIG. 4 In other words, the table 400 of FIG. 4 may be assembled by determining the groupings of electronic transaction data that have a highest COL factor, regardless of the variable to which the highest COL factor is associated with.

In particular, FIG. 4 shows a feature_name column 402, which may be a name or identifier for the variable of the transaction data. In FIG. 4, the variable CAM20_EMS_SCORE_model_score1 had a grouping for which the COL factor was the highest amongst all the groupings of the variable determined at other operations in FIG. 2. The CAM20_EMS_SCORE_model_score1 variable may be a score output by a predictive model related to each transaction to score how likely it is that a given transaction is fraudulent, for example. Column 404 is a variable type indicator, showing whether the variable is numerical (e.g., a number) or categorical (e.g., text-based). Column 406 shows a condition and column 408 shows a variable threshold related to the grouping. The table 400 further includes information about calculated COL factors 410, bad rates 412, and catch rates 414 for the variable groups to which they relate (though in this example the specific COL factors, bad rates, and catch rates values are not shown).

For the top variable CAM20_EMS_SCORE_model_score1, which had the highest COL factor, the grouping that had that highest COL factor was those transactions with a variable value of 685 or higher as indicated by the values in columns 406 and 408. The next highest variable was a United States Dollar Amount (USD_AMT) of the transactions, a numerical variable where the second highest COL factor overall (and highest for the USD_AMT variable) was those transactions that were for fifty USD or over (again as indicated in the columns of the table 400). Accordingly, the table may be determined using the groupings and the calculated COL factors. In the example of FIG. 4, the CAM20_EMS_SCORE_model_score1 variable is shown twice, as those transactions with that variable equal to or higher than 560 also had a relatively high overall COL factor. However, when building the ANT as shown in FIG. 5, the second instance of the CAM20_EMS_SCORE_model_score1 may not be used since it was already used. In other words, the second instance may be kept in the table of FIG. 4, but is deduplicated from the list or otherwise not used in the building of the ANT itself. The additional instance may be omitted, for example, because it does not add much incremental benefit to the ANT or its associated output since the related variable has already been used for a previous split in the ANT.

Some variables may be categorical rather than numerical. For example, the sixth variable listed in the table 400, the IS_YOUNG_FIRST variable, may indicate yes or no (e.g., one or zero, respectively) that the transaction is a new user's first transaction (e.g., a new user's first transaction may be characterized as a young first transaction). Accordingly, in the table 400, the grouping where transactions where a young first transaction (e.g., IS_YOUNG_FIRST equals exactly one) had a relatively high COL factor (e.g., the sixth highest of all groups for which a COL factor was calculated to assemble the table 400). In various embodiments, a variable may be a numerical value indicating how many transactions a user has executed or attempted to execute. In various embodiments, a variable may be a true/false or yes/no value indicating that the number of transactions a user has executed or attempted to execute is at or below a predetermined threshold (e.g., at or below three transactions, five transactions, ten transactions, etc.).

As noted above, the table 400 may be assembled such that the variable listed first may be associated with a grouping having a highest COL factor, and the rest of the table 400 are the next groupings with highest COL factors in descending order. The columns 406 and 408 may also be filled in based on the aspects of the groupings themselves that have high COL factors, as described herein. The table 400 may further be used to build an attack narrative tree (ANT) as shown in and described with respect to at least operation 264 of FIG. 2 and FIG. 5. As such, in determining the groupings for ordering in the table 400, the computer system may ultimately determine subsets of an overall set of electronic transactions based on variables associated with the transactions and COL factors associated with particular values or ranges of values of those variables, such that the table 400 (or similar) may be compiled that includes references to different groupings based on the variables and calculated COL factors.

At an operation 264, an attack narrative tree (ANT) is built using the electronic transaction data using the data assembled (e.g., variable ordering and threshold variable values) into the table 400 (e.g., at the operations 260, 262), which is assembled based on the groupings (e.g., created at the operations 254, 256) and the COL factors (e.g., calculated at the operation 258). FIG. 5 shows an example ANT 500 that may be assembled according to various embodiments herein. An end result or goal of the ANT 500 may include determining a subset of a total group of electronic transactions that have a high COL (e.g., high bad rate and high catch rate as described herein). This may generally be accomplished, as described in more detail herein, by reducing the total group of electronic transactions to a first subset of electronic transactions based on a first entry in a table such as the table 400, then reducing the first subset of the electronic transactions to a second subset of electronic transactions based on a second entry in a table such as the table 400, and so on until an end condition is reached. Once an end condition is reached, the end of the tree may indicate aspects or variables of transactions (e.g., of whatever set of transactions remain after tree-splitting) that are highly indicative of fraud.

In various embodiments, the columns or entries in a table such as the table 400 may be updated as the ANT 500 is built. In other words the COL factors for the remaining variables and groups of transactions created from those variables may be recalculated based on the transactions that are being kept after a split in the ANT 500. In this way, a more optimal next split may be determined so that the ANT 500 may be optimized and better fitting characteristics of fraudulent transactions may be identified. In other words, a process similar to that shown in operations 258, 260, and 262 may be performed on the transactions that remain after a portion of the tree is split (e.g., the transactions that remain after it is determined that one of groups 504, 508, 510, 512, 514, 516 may be kept as discussed below).

Advantages of the ANT and how it is constructed, split, ended, etc. may be that groups of transactions with higher COL factors are identified for further study, blocking similar future transactions, etc. Further advantages may include reducing computational costs in analyzing transactions because the tree splitting quickly cuts down a total number of transactions being analyzed from an initial group of transaction data. Further advantages relate to time spent to analyze a large group of transaction data, as the lowered compute resources may allow for fast processing of data, which may lead to recognition of new patterns of fraudulent transactions more quickly, which may further allow for a system to be adjusted more quickly to address fraud in future electronic transactions in a system.

As discussed further below with respect to the specific example of an ANT shown in FIG. 5, the table 400 variables may be used to build and split the branches of an ANT. The embodiments herein provide for tree split criteria that results in lower entropy and higher concentration of loss in the ultimate sub-tree ends and outputs of the ANT, so that patterns of more fraudulent transactions that have higher transaction amounts (e.g., have a high COL factor) may be identified, analyzed, etc.

When building the ANT, different sub-tree end conditions may be used or defined. In particular a sub-tree end condition may be the point at which the subsets of the tree should not be reduced further. For example, once a sub-tree branch end is determined to be associated with a group of transactions that has a bad rate at or below a particular, predetermined threshold, those transactions may be discarded and/or the sub-tree is ended. In another example, once a sub-tree branch end is determined to be associated with a group of transactions that has a catch rate at or below a particular, predetermined threshold, those transactions may be discarded and/or the sub-tree is ended. A threshold for ending a branch of the tree and discarding the data may also be a combination of bad rate and catch rate, including for example a COL factor of the related transactions (as COL accounts for bad rate and catch rate). Sub-tree end conditions may also define when a branch of an ANT should be ended as it contains valuable data to output. For example, a sub-tree may be ended and output when a bad rate, catch rate, or COL is at or above a particular threshold (or a sub-tree end condition may be a combination of any of bad rate, catch rate, and COL). In this way, the tree may be built using the variables and value thresholds previously assembled (e.g., from the table 400) and ended based on various sub-tree end conditions, where some conditions define when to discard data and end a sub-tree and other conditions define when to keep/output data and end a sub-tree. In this way, the portions of the tree that are less indicative of fraudulent electronic transactions may be discarded, as they may not be worth the time and computational resources to continue exploring. Determining when to end a tree due to a good performing branch may be configured to avoid overfitting an end branch to fraudulent transaction characteristics.

Turning to the specific example ANT 500 of FIG. 5, sub-tree end conditions may be used to determine when to keep transaction data and output data related to those transactions as indicating a high level of fraudulent transactions. The sub-tree end conditions may be determined automatically, may be input as hyperparameters by a user via a user interface, or some combination of the two. For example, in the ANT 500, sub-tree end conditions where transaction data may be kept and output as indicating a high level of fraudulent transactions may include that the bad rate of a sub-tree level is at least a certain rate (e.g., 12% in the example of FIG. 5) and that the max depth of the tree is at least three levels. If these two conditions are met, the transaction data associated with that sub-tree may be kept and data output accordingly. Sub-tree end conditions associated with when to end a tree based on low COL (e.g., such that the transaction data is not kept as indicating a high level of fraudulent transactions) may also be used. For example, sub-tree end conditions for not keeping certain data may be (i) where a bad rate is lower than the bad rate of the initial group of transactions at a top level of the tree (e.g., where the bad rate is below 3% in the example of FIG. 5), (ii) where a sub-tree depth has reached a predetermined threshold value (e.g., a max depth hyperparameter entered by the user or a default depth) such as 8 levels, or (iii) where a catch rate is below a predetermined threshold value (e.g., as set by a user as a hyperparameter or below a default value). For example, in FIG. 5, sub-tree end conditions for discarding data may be where a bad rate is below the bad rate of the original data set at the beginning of a tree and where a catch rate is at or below 10%. In addition, default rules or user set rules may be applied to the tree, such as a maximum depth of the tree. For example, a maximum depth for the tree may be eight levels, with five levels as a buffer zone for additional exploring such that a user may choose to go five levels above and/or below the eighth level as desired, where after eight levels if a sub-tree end condition for keeping valuable data (e.g., data where there is a high bad_rate) has not been found, the building of the tree may be ceased (unless the user chooses to go further, in various embodiments). A user may optionally adjust different hyperparameters and build a different tree to attempt to find a valuable sub-tree end condition, and/or may use a different data set of electronic transactions to build a new tree. Various thresholds and conditions as described herein may be adjusted to different predetermined thresholds as desired for different ANTs and/or multiple ANTs may also be assembled for the same group of electronic transaction data using different predetermined thresholds/sub-tree end conditions.

A first group 502 of the ANT 500 includes all of the transactions of a plurality of electronic transactions that was originally part of the dataset (e.g., transaction data received at the operation 252 of FIG. 2). The bad rate may be three percent, indicating that three percent of all the transactions are fraudulent, and the catch rate may be one hundred percent, indicating that of all the total money known to be associated with fraudulent transactions in the overall group of electronic transactions, one hundred percent of that total amount of money is captured in the transactions represented by the highest sub-tree level of the first group 502. This makes sense because the first group 502 represents all the transactions in the data set being analyzed so there would be no amounts of fraudulent transactions outside the data set.

The first group 502 of transaction data may then be split according to the first condition presented in the first row of the table 400. That is, for the variable CAM20_EMS_SCORE_model_score1 (“CAM20”) where the scores are greater than or equal to 685, those transactions are split into group 504, while transactions with scores below 685 are split into group 506. As shown in FIG. 5, the bad rate of the transactions in the group 506 is low at 0.4%, so those transactions meet a sub-tree end condition where the data in the group 506 is discarded or no longer considered (e.g., is not output as useful data for identifying fraudulent transactions). The group 504 is split again using the second row of the table 400. In particular, where the amount is at or above fifty USD the transactions are split into group 508, and transactions below fifty USD are split into group 510. However, both groups have relatively high bad rates and catch rates, so they both capture useful data. The group 508 also has a bad rate above 40%, so this may meet a sub-tree end condition of useful data that may be output (e.g., to a user to indicate that transactions with a CAM20 score at or above 685 and having an amount at or above 50 USD are likely to be fraudulent), and the sub-tree may be ended there to avoid overfitting.

The group 510 may be further split using the fourth row in the table 400. In various embodiments, a row in a table such as the third row of FIG. 4 may be intentionally skipped. For example, applying a particular row may not decrease entropy and increase COL at the same time (e.g., there is a high overlap or similarity in groups when a sub-tree is split) and in such scenarios that row in the table may be skipped and a next row used instead. The system, for example, may automatically determine that a particular row does not sufficiently decrease entropy and increase COL at the same time for a split based on a particular row, and determine that the entropy does not decrease by more than a predetermined threshold or the COL does not increase by a predetermined threshold at a single split. Upon determining that a split based on a particular variable (e.g., row of FIG. 4) does not decrease entropy and increase COL at a same time and therefore is not valuable for continuing to build the ANT, that row may be skipped and the system may move onto the next row. In the particular example of FIG. 4, the third row associated with the variable v78_rcvr_fs_availability is skipped, and the fourth row variable CAM20_INELG_SCORE1 is used, which may be a variable related to a predictive model risk score. Where that score is at or above 616, the transactions are split into group 514, and where that score is below 616, the transactions are split into group 512. Again, both the groups 514 and 512 have relatively high bad and catch rates (e.g., the bad and catch rates do not meet a sub-tree end condition), so they are both kept and further considered.

The group 514 may then be split based on a next row in the table 400. However, the next row (fifth row) in the table is the same variable as was used in the first row of the table. As such, the fifth row may be skipped due to it being less instructive for decreasing entropy and increasing COL than the first row, which was already used. Accordingly, the transactions from the group 514 may be split according to the variable IS_YOUNG_FIRST (the sixth row of the table 400), which represents whether a given transaction is a user's first transaction, where transactions that are a user's first (e.g., IS_YOUNG_FIRST is exactly equal to one) are split into group 516 while transactions that are not a user's first (e.g., IS_YOUNG_FIRST is not equal to one) are split into group 518. The sub-tree ends based on one more level being applied after the group 514. The data associated with the group 518 may be discarded or not output because a sub-tree end condition of having a bad rate below 3% applies. The data associated with the group 516 may be kept and output since the sub-tree bad rate is 17%, which is above a sub-tree end condition for keeping data of being above the predetermined threshold of 12% bad rate in this example. Indeed, the group 516 shows a high bad rate of 17% and a high catch rate of 57%, indicating that a high number of transactions and a high transaction amount of the percentage of the total amount that is fraudulent is captured by the group 516. As such, the group 516 is a valuable set of transactions to analyze, and other transactions with similar properties (CAM20 score at or above 685, USD_AMT below 50, CAM20_INELG_SCORE1 at or above 616, and IS_YOUNG_FIRST is exactly equal to one) may be studied, flagged, blocked, etc. as desired based on the output of the ANT.

The group 512 may also be further split. As discussed above, the fifth row in the table 400 may be skipped since that variable has already been used. In addition, as discussed herein, a split of the group 512 may not decrease entropy and increase COL at a same time (e.g., there is a high overlap or similarity in groups when a sub-tree is split). That may be determined by calculating the COL, bad rate, and/or catch rate of the sub-trees from a split, as discussed herein. In the example ANT 500 of FIG. 5, when the group 512 is split according to the sixth row of the table 400 (using variable IS_YOUNG_FIRST), the resulting blocks or sub-trees does not sufficiently decrease entropy or yield a block that increases COL by a desired threshold. As such, the sixth row may be skipped for splitting the group 512, and the seventh row is used instead. The variable v50_e_dom_riskiness_rcvr associated with the seventh row may be a text value, where the condition is exactly equals the text string CMN_DOM, such that transactions that don't have the value CMN_DOM are split into group 522 and transactions with the value CMN_DOM are split into group 520. As shown, both the groups 520 and 522 have a low bad rate or low catch rate such that a sub-tree end condition for discarding data is triggered. As such, neither of the groups are kept or output.

At an operation 266, a report is output by the system based on the ANT built at the operation 264 (e.g., the ANT 500 of FIG. 5). For example, the report may include information about the groups 508 and 516 that are indicative of groups of transactions having characteristics that may be indicative of fraud. FIG. 6 shows example output logic 600 of a report for such transactions (e.g., those related to the groups 508 and 516). In this way, the logic output 600 may be used by backend clients/users of a system, for example, to set up fraud monitoring and/or detection systems using the variables and thresholds in the output that align with the groups 508 and 516. The output logic 600 may also indicate for each group of sub-tree logic what the bad rate and catch rate for that data was from the historical electronic transaction data the ANT 500 was built from. For example, for the block 508, the bad rate 602 and catch rate 604 is shown. For the block 516, the bad rate 606 and the catch rate 608 is shown. The output report may further include the table 400 of FIG. 4 and its associated data. This table may be useful, for example, to present characteristics of fraudulent transactions associated with a high COL factor that have been identified in an easy to read and understand format. These reports or outputs may be used in various ways.

For example, FIG. 7 is a flow chart illustrating an example method 700 of using an output of an attack narrative tree to detect fraudulent electronic transactions. At an operation 702, a computing system (e.g., a backend client system) may receive and display an output report from an ANT. At an operation 704, filters may be set by a user to determine historical transactions (e.g., transactions that have already occurred), new transactions (e.g., transactions that have been authorized or executed within a predetermined threshold of time from the present time), or pending electronic transactions (e.g., transactions that may be in the process of being authorized, executed, requested, etc.) that may have characteristics identical to or similar to those transactions identified in the output report. In other words, an output report may be used to identify additional transactions (whether executed or not) that may be fraudulent based on their similarity to those identified in a group of an ANT as having high bad rate, catch rate, or COL factor. For example, the transactions analyzed to build an ANT may already have known fraudulent transactions included in that transaction data. Once characteristics of those fraudulent transactions are identified by building an ANT, those characteristics may be applied to or used to analyze transaction data for which it is unknown whether those transactions are fraudulent. As such, the unknown transaction data may be filtered or reduced using the characteristics identified by building the ANT so that determining fraudulent transactions from the unknown data may be faster, more accurate, use less computing resources, have a higher coverage of loss, etc.

At an operation 706, an action may be taken by a backend user after other transactions with similar or identical characteristics are identified. For example, investigations into those identified transactions may be launched, refunds may be issued to customer accounts that have been defrauded, reports (e.g., law enforcement reports, reports to banking or credit card institutions) may be assembled and sent to interested parties, etc. Such actions may be specified through a user interface on a backend user device, client device, or may be triggered automatically based on a predetermined rule set up for when certain transaction data is determined to be potentially fraudulent. If transactions identified have not yet been authorized or processed, the action may involve suspending the transaction, canceling the transaction, declining to authorize or process the transaction, etc.

FIG. 8 is a flow chart illustrating an example method 800 of using an output of an attack narrative tree to analyze in-process electronic transactions. At an operation 802, a computing system (e.g., a backend client system) may receive and display an output report from an ANT. At an operation 804, filters may be set to flag electronic transactions that have not yet been approved or authorized. For example, the output report may identify characteristics of potentially fraudulent transactions, and those characteristics may be used to set flags or filters in a payment processing system (e.g., the electronic transaction processing server(s) 172 of FIG. 1). In this way, for even transactions that have not yet been requested/initiated, the system may have predetermined filters/flags set up to catch certain transactions that have the characteristics matching an output report.

At an operation 806, those transactions are actually flagged using the filter condition(s) established at the operation 804. At an operation 808, an automated action may be taken based on the transactions being flagged prior to authorizing or processing the transaction. For example, investigations into those identified transactions may be launched, reports (e.g., law enforcement reports, reports to banking or credit card institutions) may be assembled and sent to interested parties, the transactions may be suspended or canceled for further investigation/analysis, a user involved in the transaction may be prompted for more information to verify that they are an authorized user of a particular account before the transaction is processed/authorized, etc. Such actions may be specified through a user interface on a backend user device, client device, etc. as automatically executable rules based on the filters/flags set up at the operation 804. That is, when the flags or filters are established at the operation 804, rules for what actions the payment processing system should take upon flagging a transaction as potentially fraudulent may also be established.

Accordingly, described herein are various systems, methods, and computer readable media for building attack narrative trees (ANTs) that may be used to identify characteristics of fraudulent or potentially fraudulent electronic transactions. Those characteristics may be used to further identify other electronic transactions that may be fraudulent and implement additional actions based on that identification as desired.

FIG. 9 is a diagrammatic view of an example of a computing environment that includes a general-purpose computing system environment 100, such as a desktop computer, laptop, smartphone, tablet, or any other such device having the ability to execute instructions, such as those stored within a non-transient/non-transitory, computer-readable medium/media. Various computing devices as disclosed herein (e.g., the client systems 162, 164; the client account server system 168; the backend client system 174, the electronic transaction processing server(s) 172, or any other device) may be similar to the computing system 100 or may include some components of the computing system 100. Furthermore, while described and illustrated in the context of a single computing system 100, those skilled in the art will also appreciate that the various tasks described hereinafter may be practiced in a distributed environment having multiple computing systems 100 linked via a local or wide-area network in which the executable instructions may be associated with and/or executed by one or more of multiple computing systems 100.

In its most basic configuration, computing system environment 100 typically includes at least one processing unit 102 and at least one memory 104, which may be linked via a bus 106. Depending on the exact configuration and type of computing system environment, memory 104 may be volatile (such as RAM 110), non-volatile (such as ROM 108, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 112, a magnetic disk drive interface 114, and/or an optical disk drive interface 116. As will be understood, these devices, which would be linked to the system bus 106, respectively, allow for reading from and writing to a hard disk 118, reading from or writing to a removable magnetic disk 120, and/or for reading from or writing to a removable optical disk 122, such as a CD/DVD ROM or other optical media. In various embodiments, other types of memory may be connected to or be part of the system and be accessed via a drive interface connected to the system bus 106, such as flash or solid-state memory devices. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 124, containing the basic routines that help to transfer information between elements within the computing system environment 100, such as during start-up, may be stored in ROM 108. Similarly, RAM 110, hard drive 118, solid-state memory, flash memory, and/or peripheral memory devices may be used to store computer executable instructions comprising an operating system 126, one or more applications programs 128 (which may include the functionality disclosed herein, for example), other program modules 130, and/or program data 132. Still further, computer-executable instructions may be downloaded to the computing environment 100 as needed, for example, via a network connection.

An end-user may enter commands and information into the computing system environment 100 through input devices such as a keyboard 134 and/or a pointing device 136. While not illustrated, other input devices may include a microphone, a joystick, a game pad, a scanner, etc. These and other input devices would typically be connected to the processing unit 102 by means of a peripheral interface 138 which, in turn, would be coupled to bus 106. Input devices may be directly or indirectly connected to processor 102 via interfaces such as, for example, a parallel port, game port, firewire, or a universal serial bus (USB). To view information from the computing system environment 100, a monitor 140 or other type of display device may also be connected to bus 106 via an interface, such as via video adapter 142. In addition to the monitor 140, the computing system environment 100 may also include other peripheral output devices, not shown, such as speakers and printers.

The computing system environment 100 may also utilize logical connections to one or more computing system environments. Communications between the computing system environment 100 and the remote computing system environment may be exchanged via a further processing device, such a network router 152, that is responsible for network routing. Communications with the network router 152 may be performed via a network interface component 154. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the computing system environment 100.

The computing system environment 100 may also include localization hardware 186 for determining a location of the computing system environment 100. In some instances, the localization hardware 156 may include, for example only, a GPS antenna, an RFID chip or reader, a WiFi antenna, or other computing hardware that may be used to capture or transmit signals that may be used to determine the location of the computing system environment 100.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

In an illustrative embodiment, any of the operations described herein may be implemented at least in part as computer-readable instructions stored on a computer-readable medium or memory. Upon execution of the computer-readable instructions by a processor, the computer-readable instructions may cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or from practice of the disclosed embodiments. It is intended that the scope of the invention be defined by the claims appended hereto and their equivalents.

What is claimed is:

1. A method comprising:
determining, by a computer system, for each one of at least two variables associated with each one of a plurality of electronic transactions, at least a first group of the plurality of electronic transactions and a second group of the plurality of electronic transactions;
determining, by the computer system for each of the at least the first group of transactions and the second group of transactions, a factor indicative of both a percentage of electronic transactions in a group that are fraudulent and a percentage of a total amount associated with the electronic transactions in the group that are fraudulent;
determining, by the computer system, a subset of the plurality of electronic transactions based on a variable of the at least two variables having or exceeding a predetermined threshold value, wherein the predetermined threshold value is determined based on the factor of the first group and the second group.

2. The method of claim 1, wherein:
a first quantity of the first group of the plurality of electronic transactions is greater than a second quantity of the second group of the plurality of electronic transactions, and
each one of the second quantity of the second group is included in the first group.

3. The method of claim 1, wherein one of the at least two variables associated with each one of the plurality of electronic transactions comprises data indicative of whether a transaction is a first transaction of a user or whether a transaction is within a predetermined threshold of the first transaction of the user.

4. The method of claim 1, wherein one of the at least two variables associated with each one of the plurality of electronic transactions comprises data indicative of an institution through which the electronic transaction is processed, an identity of the user associated with the electronic transaction, or a type of user who processed the transaction.

5. The method of claim 1, wherein the plurality of electronic transactions comprises multiple historical electronic transactions previously deemed to be fraudulent.

6. The method of claim 5, wherein the plurality of electronic transactions comprises fraudulent electronic transactions that were completed and fraudulent electronic transactions that were not completed.

7. The method of claim 1, wherein a first variable of the at least two variables comprises, for each of the plurality of electronic transactions, a value of one of a plurality of discrete values.

8. The method of claim 7, wherein the first variable comprises whether a transaction is a first transaction of a user, whether a transaction is within a predetermined threshold of the first transaction of the user, an institution through which the electronic transaction is processed, an identity of the user associated with the electronic transaction, or a type of user who processed the transaction.

9. The method of claim 1, wherein a first variable of the at least two variables comprises, for each of the plurality of electronic transactions, a transaction amount or a calculated risk score of an electronic transaction.

10. A system comprising:
a processor; and
a non-transitory computer-readable medium having stored thereon instructions that are executable by the processor to cause the system to perform operations comprising:
determine for each of a first variable and a second variable associated with each one of a plurality of electronic transactions, a factor associated with each of a plurality of values or ranges of values of each respective variable, wherein the factor is indicative of both a percentage of electronic transactions of the plurality of values or ranges of values that are fraudulent and a percentage of a total amount associated with the electronic transactions in the group that are fraudulent;
determine a first subset of the plurality of electronic transactions based on the first variable and the factor associated with the plurality of values or ranges of values of the first variable;
determine a second subset of the plurality of electronic transactions from the first subset of the plurality of electronic transactions based on the second variable and the factor associated with the plurality of values or ranges of values of the second variable, wherein the second variable is used to determine the second subset of the plurality of electronic transactions after the first variable is used to determine the first subset of the plurality of electronic transactions based on the factor of at least one of the plurality of values or ranges of values of the first variable being higher than the factor of at least one of the plurality of values or ranges of values of the second variable.

11. The system of claim 10, wherein the factor comprises a product of:
the percentage of electronic transactions of the plurality of values or ranges of values, and
the percentage of the total amount.

12. The system of claim 11, wherein at least one of the percentage of electronic transactions or the percentage of the total amount is weighted.

13. The system of claim 12, wherein the instructions further cause the system to perform operations comprising:
receive, via a user interface, a weight to apply to either of the percentage of electronic transactions or the percentage of the total amount for calculating the factor.

14. The system of claim 13, wherein the instructions further cause the system to perform operations comprising:
determine a third subset of the plurality of electronic transactions from the second subset of the plurality of electronic transactions based on the factor of a third variable.

15. A non-transitory computer-readable medium having stored thereon instructions that are executable by a processor to cause a system to perform operations comprising:
determine for each of a first variable and a second variable associated with each one of a plurality of electronic transactions, a concentration of loss factor associated with each of a plurality of values or ranges of values of each respective variable; and
determine a subset of the plurality of electronic transactions based on the plurality of values or ranges of values of each respective variable, the determining the subset comprising:
reduce the plurality of electronic transactions to a first subset of electronic transactions based on a first value or range of values of the first variable or the second variable having a highest concentration of loss factor of each of the plurality of values or ranges of values of the first variable and the second variable; and
reduce the first subset of electronic transactions to a second subset of electronic transactions based on a second value or range of values of the first variable or the second variable having a next highest concentration of loss of the plurality of values or ranges of values of the first variable and the second variable, provided that the second value or range of values is not associated with a same variable as the first value or range of values having the highest concentration of loss.

16. The non-transitory computer readable medium of claim 15, wherein the concentration of loss factor is indicative of both a percentage of electronic transactions of the plurality of values or ranges of values that are fraudulent and a percentage of a total amount associated with the electronic transactions in the group that are fraudulent.

17. The non-transitory computer readable medium of claim 15, instructions that are executable by a processor to cause a system to perform operations comprising:
reduce the second subset of electronic transactions to a third subset of electronic transactions based on a third value or range of values of a third variable having a highest concentration of loss factor amongst a third plurality of values or ranges of values of the third variable.

18. The non-transitory computer readable medium of claim 17, instructions that are executable by a processor to cause a system to perform operations comprising:
determine that the third subset of electronic transactions should not be further reduced based on determining that the third subset has a percentage of electronic transactions of the plurality of values or ranges of values that are fraudulent that is below a predetermined threshold.

19. The non-transitory computer readable medium of claim 17, instructions that are executable by a processor to cause a system to perform operations comprising:
determine that the third subset of electronic transactions should not be further reduced based on determining that the third subset has a percentage of a total amount associated with the electronic transactions in the group that are fraudulent that is above a predetermined threshold.

20. The non-transitory computer readable medium of claim 15, wherein the concentration of loss factor is indicative of at least one of a percentage of electronic transactions of the plurality of values or ranges of values that are fraudulent or a percentage of a total amount associated with the electronic transactions in the group that are fraudulent.
